(19) United States
(12) Patent Application Publication
(10) Pub. No.: US 2026/0018845 A1
(43) Pub. Date: Jan. 15, 2026

(54) Method For Manufacturing Electronic Component, Electronic Component, And Bus Bar

(71) Applicant: SUMIDA CORPORATION, Tokyo (JP)

(72) Inventors: Takenori FUKUCHI, Natori City (JP); Hiroaki MURAKAMI, Natori City (JP); Ryoga KOYAMA, Natori City (JP)

(21) Appl. No.: 19/338,368

(22) Filed: Sep. 24, 2025

Related U.S. Application Data
(63) Continuation of application No. PCT/JP2023/013994, filed on Apr. 4, 2023.

(51) Int. Cl. H01R 43/16; H01R 43/24; H02G 5/04

(52) U.S. Cl. CPC H01R 43/16; H01R 43/24; H02G 5/04

(57) ABSTRACT

An electronic component includes a main body that includes an electronic element, a bus bar that is electrically connected to the electronic element, and a cover portion that covers a part of an outer surface of the bus bar. A method for manufacturing an electronic component includes molding the cover portion. In molding the cover portion, a pressing member including a pressing surface with unevenness is used. In molding the cover portion, the pressing member covers another part of the outer surface such that the pressing surface comes into pressure contact with the another part, the cover material is placed around the pressing member to mold the cover portion, and the unevenness is transferred to the another part when the pressing surface comes into pressure contact with the another part, thereby forming an unevenness structure.

### CROSS REFERENCE TO RELATED APPLICATIONS

This application is a continuation of International Patent Application no. PCT/JP2023/013994, filed on Apr. 4, 2023, which is expressly incorporated herein by reference in its entirety.

### BACKGROUND

### Technical Field

The present invention relates to a method for manufacturing an electronic component, and an electronic component and a bus bar manufactured by the method.

### Related Art

Some bus bars used for wiring are partially embedded in a resin. With regard to such a type of technique, Japanese Patent Laid-Open No. 2019-215997 (Patent Document 1) below discloses a bus bar insert component 10 including a main body 12 made of a synthetic resin and a bus bar 14. The bus bar 14 includes a connection portion 18 that is connected to another member and protrudes outside the main body 12, and a buried portion 16 that is buried in the synthetic resin main body 12. In Patent Document 1, the synthetic resin main body 12 of the bus bar insert component 10 is formed by insert molding.

On the other hand, there are some bus bars in which an unevenness structure is formed on a contact surface that comes into contact with another member (hereinafter, also referred to as a contacting member) electrically connected to the bus bar. The unevenness structure may be formed by laser irradiation or press processing.

The bus bar having the unevenness structure on the contact surface thereof and partially embedded in a cover material such as a synthetic resin is generally manufactured by sequentially performing a step for forming the unevenness structure on the contact surface and a molding step of covering a part of the bus bar with the cover material. However, a problem occurs in that a manufacturing process becomes complicated due to a plurality of steps.

The present invention has been made in consideration of the above problems, and is to provide a method for manufacturing an electronic component that is easy to manufacture, an electronic component, and a bus bar.

### SUMMARY

The present invention provides a method for manufacturing an electronic component including a main body that includes an electronic element, a bus bar that is electrically connected to the electronic element, and a cover portion that covers a part of an outer surface of the bus bar, the method including molding the cover portion by placing a cover material on the part. In molding the cover portion, a pressing member including a pressing surface with unevenness is used, the pressing member covers another part of the outer surface such that the pressing surface comes into pressure contact with the another part, the cover material is placed around the pressing member to mold the cover portion, and the unevenness is transferred to the another part when the pressing surface comes into pressure contact with the another part, thereby forming an unevenness structure.

The present invention provides an electronic component including: a main body that includes an electronic element; a bus bar that is electrically connected to the electronic element; and a cover portion that covers a part of an outer surface of the bus bar, in which, an unevenness region having an unevenness structure is formed on a contact portion, which is exposed from the cover portion, on the outer surface.

The present invention provides a bus bar in which a part of an outer surface is covered by a cover portion, and another part of the outer surface is formed with an unevenness structure.

The pressing member is pressed against the bus bar to cover the outer surface of the bus bar in a desired range. This makes it possible to form the unevenness structure in the range due to pressure contact of the pressing member while masking the range from the cover material and molding the cover material into a desired shape.

### Effect of the Invention

According to a method for manufacturing an electronic component of the present invention, a step for molding and a step for embossing the unevenness can be performed simultaneously. This makes it possible to reduce the number of manufacturing steps and to easily manufacture an electronic component.

### BRIEF DESCRIPTION OF THE DRAWINGS

The above objects, other objects, features, and advantages will become more apparent from the following preferred embodiments and the accompanying drawings.

FIG. 1A is a perspective view showing an example of an electronic component according to a first embodiment of the present invention. FIG. 1B is a front view of a first bus bar in the electronic component according to the first embodiment.

FIG. 2 is a cross-sectional view taken along a dashed line shown in FIG. 1B of the electronic component according to the first embodiment as viewed in a direction of arrow II-II.

FIG. 3A is an enlarged cross-sectional view of a region X1 in FIG. 2B of the electronic component according to the first embodiment. FIG. 3B is an enlarged cross-sectional view of a region X2 in FIG. 2B of the electronic component according to the first embodiment.

FIG. 4 is a cross-sectional view of the electronic component according to the first embodiment when a second bus bar is attached.

FIG. 5A is an enlarged cross-sectional view of a region Y1 in FIG. 4 of the electronic component according to the first embodiment. FIG. 5B is an enlarged cross-sectional view of a region Y2 in FIG. 4 of the electronic component according to the first embodiment.

FIG. 6 is a schematic cross-sectional view illustrating a manufacturing process of the electronic component according to the first embodiment.

FIG. 7 is a schematic cross-sectional view illustrating a manufacturing process of the electronic component according to the first embodiment, and shows a state in which a pressing member and a first bus bar come into pressure contact with each other.

### DETAILED DESCRIPTION

Various components of an electronic component and a bus bar according to the present invention do not need to be individually independent. Various components are allowed, for example, one member may be formed of a plurality of components, one component may be formed of a plurality of members, a component may be part of another component, or part of a component may be duplicated as part of another component.

In a manufacturing method of an electronic component of the present invention, a plurality of steps are sequentially described; however, the sequence of the descriptions of the steps does not limit the sequence or timing to execute the plurality of steps. For this reason, when the manufacturing method of the electronic component of the present invention is performed, the sequence of the plurality of steps is capable of being changed without departing from the content, and part or the entirety of the timings to execute the plurality of steps may be duplicated.

Hereinafter, embodiments of the present invention will be described with reference to the drawings. In all of the drawings, the same reference numerals will be given to the same components, and thus will not be described as appropriate.

In the present embodiment, an x direction, a y direction, and a z direction are defined as shown in the drawings. However, these are defined for the sake of convenience in order to easily describe the relative relationships between components, and do not limit the directions during the manufacture or use of the product embodying the present invention.

Further, a term “flat surface” as used herein means a shape that is physically formed with a flat surface as a goal, and it is not necessarily required that the surface be a geometrically perfect flat surface.

### Overview of First Embodiment

### (Electronic Component)

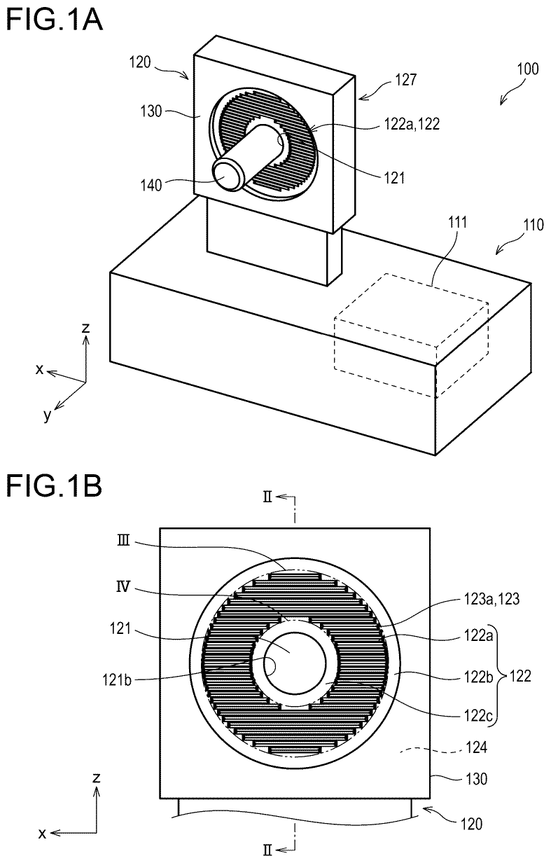

FIG. 1 is a schematic diagram showing an example of an electronic component 100 according to a first embodiment of the present invention.

First, an overview of the electronic component 100 according to the present embodiment will be described.

The electronic component 100 includes a main body 110, a first bus bar 120, and a cover portion 130. The main body 110 includes an electronic element 111. The first bus bar 120 is electrically connected to the electronic element 111. The cover portion 130 covers a part of an outer surface of the first bus bar 120. A contact portion 122 is formed with an unevenness region 122a having an unevenness structure 123. The contact portion 122 is a portion on the outer surface exposed from the cover portion 130.

The electronic component 100 has a shape that can be manufactured by a manufacturing method to be described below.

Next, the electronic component 100 according to the present embodiment will be described in detail.

The electronic component 100 refers to a portion including the electronic element 111 that constitutes an electronic circuit. In particular, the electronic component 100 refers to components that can be connected to or removed from the contacting member. The electronic element 111 is a component in the electronic component 100, and is a part including a core or a coil that constitutes an electronic circuit. A main function of the electronic component 100 is implemented by the electronic element 111. The electronic element 111 may include a core or a coil, and the electronic component 100 may be, as a whole, a coil component such as an inverter, an inductor, a transformer, or an antenna. In the present embodiment, the electronic component 100 is an in-vehicle electronic component that constitutes an electric device mounted on a vehicle body of an automobile. More specifically, an example of the electric device includes a battery device such as a lithium ion battery or an all-solid-state battery mounted on an electric vehicle. The electronic component 100 may be any of various reactors that are connected to an electric device, which is an in-vehicle battery device, and a current is applied to the reactors during charging or discharging.

The main body 110 is a part of the electronic component 100, and includes the electronic element 111. The main body 110 preferably includes the electronic element 111 therein. The whole of the main body 110 may be covered with a molded resin or the like. In the present embodiment, the main body 110 is a member having a shape in which a longitudinal direction is an x-axis direction, but the main body 110 may have any shape.

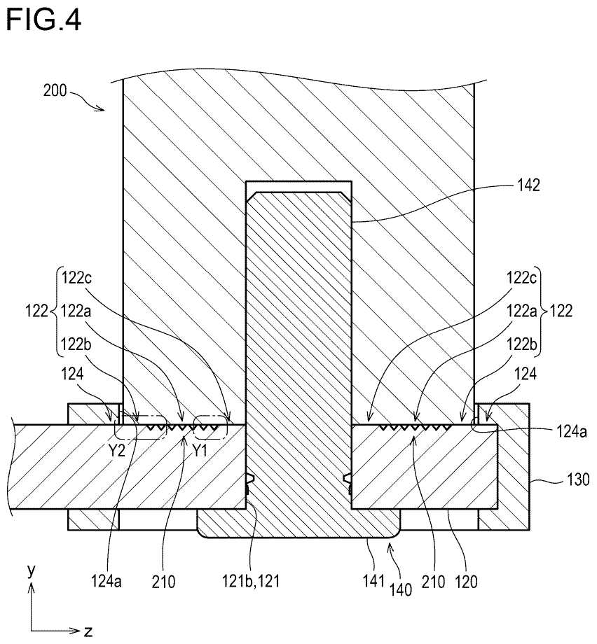

The bus bar is formed of a conductive material such as a metal containing copper. Preferably, the bus bar has an area of a cross section (a cross section cut perpendicular to a flowing direction of a current) larger than that of a wire, and has an overall shape that is substantially rod-like or plate-like. In the present embodiment, the electronic component 100 or an electric device 1 to be described below includes, as a bus bar, a first bus bar 120 or a second bus bar 200. Hereinafter, a longitudinal direction of the bus bar may refer to a direction, in which the bus bar has the largest dimension, among a height direction, a width direction, and a thickness direction of the bus bar. In the present embodiment, the longitudinal direction of the first bus bar 120 is a z-axis direction, and the longitudinal direction of the second bus bar 200 (see FIG. 4) is a y-axis direction. A cross section of the bus bar may have a polygon shape such as a rectangular shape, or may have a circular shape or an elliptical shape.

The first bus bar 120 is a member that electrically connecting a contacting member connected to the electronic component 100 with the electronic element 111. In the present embodiment, a part of a base end side (−z direction) of the first bus bar 120 is embedded inside the main body 110, and another part of a leading end side (z direction) protrudes outward from the main body 110. In the present embodiment, the first bus bar 120 is a plate-like conductive member having main surfaces facing in respective penetrating directions of a through hole 121 to be described below. In the present embodiment, the first bus bar 120 is electrically connected to the electronic element 111 inside the main body 110.

In the present embodiment, the electronic component 100 includes one first bus bar 120, but the electronic component 100 may include a plurality of bus bars 120.

The cover portion 130 is a member that is formed of an insulating material (hereinafter, referred to as a cover material) such as resin and covers a part of the first bus bar 120. The first bus bar 120 or the electronic component 100 can be improved in insulation properties or water resistance by the cover portion 130. The cover portion 130 covers at least the outer surface of the first bus bar 120 at an adjacent portion 124 to be described below. The cover portion 130 may cover other parts of the outer surface of the first bus bar 120 without being limited to the adjacent portion 124. For example, in the present embodiment, the cover portion 130 covers not only the adjacent portion 124 but also a part of an end surface of the first bus bar 120 and a part of a rear surface 127 to be described below. The cover portion 130 is preferably in close contact with the part of the outer surface of the first bus bar 120 covered by the cover portion 130, but the cover portion 130 and the part may be spaced apart from each other. In addition, a contact portion 122 (to be described below) and a part of the base end side of the bus bar 120 are not covered by the cover portion 130, and are exposed from the cover portion 130. The part of the base end side of the first bus bar 120 may be covered by the cover portion 130.

The contact portion 122 is a partial surface region of the outer surface of the first bus bar 120 and is exposed to the outside of the cover portion 130 as described above. The contact portion 122 is a partial surface region that is in contact with a contacting member (in the present embodiment, a second bus bar 200 (see FIG. 4) to be described below), or is a partial surface region that is scheduled to come into contact with the contacting member. The contact portion 122 may be configured only by the surface region that is in contact with or is scheduled to come into contact with the contacting member, or may include a surface region located around the above-described surface region and not being in contact with or not being scheduled to come into contact with the contacting member. In the present embodiment, the second bus bar 200 (particularly, a facing surface 210 (see FIG. 4)) contacts substantially the entire region of the contact portion 122, but a part of an outer edge side of the contact portion 122 does not contact with the second bus bar 200.

The unevenness region 122a is a partial region of the contact portion 122, and refers to a surface region where the unevenness structure 123 is formed. In other words, the unevenness region 122a is a region having larger unevenness than another region (for example, an outer peripheral portion 122b) adjacent to the outside of the unevenness region 122a. The unevenness region 122a is a plane region that extends in an approximately extending direction of the contact portion 122.

The unevenness region 122a is a partial surface region of one surface (a surface directed to a y direction) including the contact portion 122 on the outer surface of the first bus bar 120. The unevenness region 122a is preferably formed in a part, which overlaps the second bus bar 200 as viewed in an overlap direction (an axial direction of a shaft member 140 to be described below) when the first bus bar 120 is joined to the second bus bar 200 to be described below. In other words, the outer edge of the unevenness region 122a is preferably arranged on a central side of the overlapping portion between the second bus bar 200 and the first bus bar 120 as viewed in the overlap direction (an axial direction of a shaft member 140 to be described below) when the first bus bar 120 is joined to the second bus bar 200.

The unevenness structure 123 is a structure having a plurality of concave portions or convex portions. As described above, the unevenness region 122a has, as a whole, the unevenness structure 123, and thus has a rough surface having a larger surface roughness than a peripheral region (for example, an outer peripheral portion 122b to be described below) of the unevenness region.

Here, the concave portion in the unevenness structure 123 is a portion that is arranged on a protruding inner side of the first bus bar 120 in the unevenness region 122a, and the convex portion (which also refers to a protrusion portion 123e to be described below) of the unevenness structure 123 is a portion that is arranged on a protruding outer side of the first bus bar 120 in the unevenness region 122a. Here, the protruding inner side refers to a direction from the outer surface toward the center of the first bus bar, and the protruding outer side refers to a direction from the center toward the outer surface of the first bus bar.

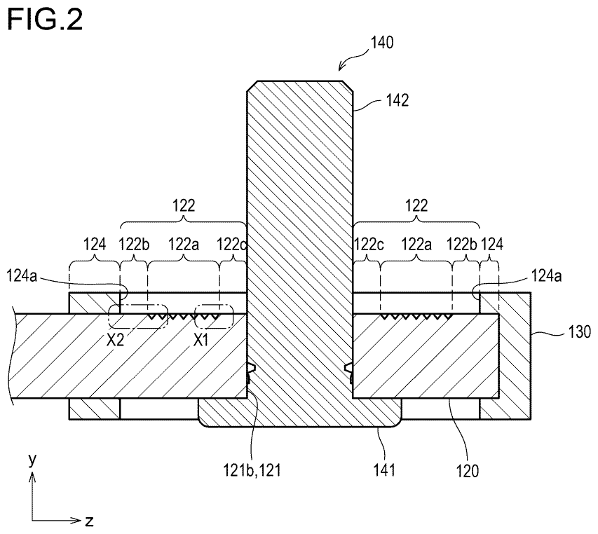

As shown in FIG. 1B, the unevenness structure 123 of the present embodiment is formed by two or more bottomed concave grooves 123a aligned with each other. The concave groove 123a is defined by a bottom portion (concave-groove bottom portion 123a1 (see FIG. 2B)) and a pair of wall portions (concave-groove wall portion 123a2 (see FIG. 2B)) that sandwich the concave-groove bottom portion 123a1 (see FIG. 2B). Here, that the concave grooves 123a are aligned with each other means that extending directions of the concave grooves 123a have the same direction component, and preferably the concave grooves 123a are approximately parallel to each other. The extending direction of the concave grooves 123a may be linear as in the present embodiment, or may wavy. Alternatively, the plurality of concave grooves 123a may have concentric circle shapes with different radii. In other words, the extending direction of the concave grooves 123a may be circular. Even when the concave grooves 123a are wavy or circular, the concave grooves 123a adjacent to each other are preferably aligned with each other.

In the present embodiment, as shown in FIG. 1B, the plurality of concave grooves 123a having substantially a linear shape extend in a direction (x-axis direction) orthogonal to the longitudinal direction of the first bus bar 120, and are also continuously lined up in the longitudinal direction (z-axis direction). As shown in FIG. 4, in the present embodiment, the first bus bar 120 and the second bus bar 200 are arranged side by side in the longitudinal direction (z-axis direction) of the first bus bar 120 while overlapping partially in the y-axis direction and coming in contact with each other. The plurality of concave grooves 123a continuously lined up in a predetermined direction, whereby the contact surface between the first bus bar 120 and the second bus bar 200 is hardly misaligned laterally in the predetermined direction. Alternatively to the present embodiment, the concave grooves 123a extend in the longitudinal direction of the first bus bar 120, and the plurality of concave grooves 123a may be aligned in the direction orthogonal to the longitudinal direction.

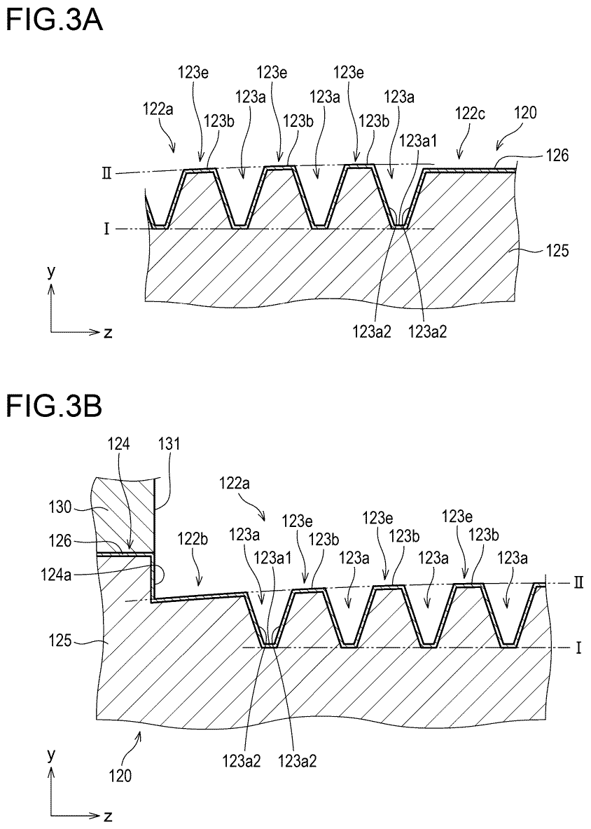

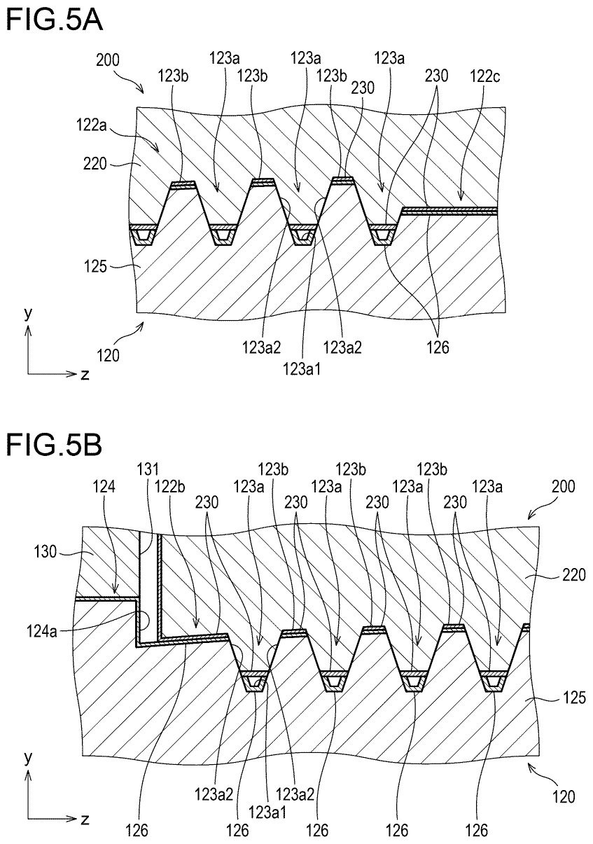

Compared to the concave groove 123a shown in FIGS. 3A, 3B, 5A, and 5B, widths of the concave-groove bottom portion 123a1 and a top portion 123b and an inclination angle of the concave-groove wall portion 123a2 shown in FIGS. 1A, 1B, 2, 4, and 6 are changed for convenience.

In the present embodiment, the unevenness structure 123 is configured by the plurality of concave grooves 123a, but alternatively to the present embodiment, the unevenness structure 123 may be configured by a plurality of scattered protrusion portions.

In the present embodiment, a partial surface region (including an adjacent portion 124), which is covered by the cover portion 130, on the outer surface of the first bus bar 120 is a region where the unevenness structure 123 is not formed. In other words, the partial surface region is planar.

As shown in FIG. 5A, the unevenness structure 123 of the present embodiment can be said to include a plurality of protrusion portions 123e as will be described below. The protrusion portion 123e is a portion that protrudes from the protruding inner side toward the protruding outer side of the first bus bar 120, and is a part of the first bus bar 120. In the present embodiment, the protrusion portion 123e is a part of the first bus bar 120 located between one concave groove 123a and another concave groove 123a adjacent to the one concave groove 123a. More specifically, the protrusion portion 123e is a part of the first bus bar 120 defined by the concave-groove wall portions 123a2 that define the concave groove 123a and the top portion 123b. In the present embodiment, the protrusion portion 123e extends in a substantially linear extending direction along the concave groove 123a.

The width of the protrusion portion 123e becomes preferably smaller toward the protruding direction of the unevenness structure 123. In addition, a protruding dimension of the protrusion portion 123e is preferably larger than a width dimension of the protrusion portion 123e (particularly, a width dimension of a base end of the protrusion portion 123e). This makes it easier for the protrusion portion 123e to fit into the second bus bar 200 in a step for joining to be described below. Hereinafter, the protruding direction of the unevenness structure 123 may be simply referred to as a protruding direction. A width direction of the protrusion portion 123e refers to any direction orthogonal to the protruding direction in which the dimension of the protrusion portion 123e is the smallest. The width dimension of the protrusion portion 123e is a dimension of the protrusion portion 123e in the width direction. In the present embodiment in which the unevenness structure 123 is formed by the plurality of concave grooves 123a aligned with each other, the width dimension of the protrusion portion 123e is a dimension of the protrusion portion 123e in the direction in which the plurality of concave grooves 123a are aligned.

As shown in FIGS. 3A and 3B, in the present embodiment, the top portion 123b is flat which is a leading end protruding in the unevenness structure 123. In other words, the top portion 123b has a predetermined width dimension.

The top portion 123b is a portion that is arranged on the protruding outer side of the first bus bar 120 in the unevenness structure 123. In the present embodiment, regions located between the plurality of concave grooves 123a are the top portions 123b, and the top portions 123b extend in substantially the same direction as the direction in which the concave grooves 123a extend (z-axis direction). The top portions 123b have a predetermined width dimension in the direction in which the concave grooves 123a are aligned (x-axis direction). When the unevenness structure 123 is configured by scattered protrusion portions, protruding ends of the protrusion portions are the top portions 123b.

Here, the “flat” means that the top portion 123b is planar, or a radius of curvature of the top portion 123b at a point arranged on the protruding outermost side of the protrusion portion is larger than half the width dimension of the protrusion portion (particularly, the width dimension of the protruding leading end). In other words, the top portion 123b may be a curved surface that is gently curved inward or outward of the first bus bar 120. Preferably, the radius of curvature of the top portion 123b is larger than the width dimension of the protrusion portion. More preferably, the top portion 123b is planar.

Alternatively to the present embodiment, the shape of the top portion 123b may be a shape that is sharp outward of the first bus bar 120. In other words, the radius of curvature of the top portion 123b at the point arranged on the protruding outermost side of the protrusion portion may be smaller than half the width dimension of the protrusion portion (particularly, the width dimension of the protruding leading end). Since the top portion 123b is sharp, when the first bus bar 120 and the second bus bar 200 come into pressure contact with each other, the top portion 123b can easily fit into the second bus bar 200.

Since the top portion 123b is flat, in a step for joining to be described below, the top portion 123b comes into surface contact with the surface of the second bus bar 200 before the top portion 123b fits into the second bus bar 200. This prevents the top portion 123b from slipping on the second bus bar 200. As a result, the first bus bar 120 and the second bus bar 200 can continuously come into pressure contact with each other in a desired positional relationship. In addition, the top portion 123b comes concentrically into pressure contact with a predetermined position on the surface of the second bus bar 200, making it easy to fit into the predetermined position.

When pitches of the respective concave grooves 123a are constant, it is possible to increase an inclination angle of the wall portion (the concave-groove wall portion 123a2 to be described below), which defines the concave groove 123a, relative to the outer peripheral portion 122b in a case where the top portion 123b has a width compared to a case where the top portion 123b has substantially no width and is sharp. This makes it easier for an oxide film covering the concave-groove wall portion 123a2 to peel off in the step for joining to be described below.

In the present embodiment, the width of the top portion 123b interposed between two concave grooves 123a is larger than the bottom portion of the concave groove 123a (the concave-groove bottom portion 123a1). In the present embodiment, the top portion 123b has a predetermined width dimension in the direction in which the plurality of concave grooves 123a are aligned (x-axis direction). In the present embodiment, the concave-groove bottom portion 123a1 has a predetermined width dimension in the direction in which the plurality of concave grooves 123a are aligned (x-axis direction), but is not limited thereto. The concave-groove bottom portion 123a1 may be substantially linear, and the width of the concave-groove bottom portion 123a1 may be substantially zero. Even in this case, the width of the top portion 123b is larger than the width of the concave-groove bottom portion 123a1.

Since the width of the top portion 123b is larger than the width of the concave-groove bottom portion 123a1 as described above, the width of the top portion 123b is sufficiently ensured. For this reason, misalignment between the first bus bar 120 and the second bus bar 200 is satisfactorily prevented in the step for joining as described above.

In the step for joining to be described below, the top portion 123b fits into the second bus bar 200, whereby a part of the second bus bar 200 is pushed to another location. Since the concave groove 123a is deeply formed until the width of the concave-groove bottom portion 123a1 is sufficiently small, the part of the second bus bar 200 can fit into the bottom side of the concave groove 123a without pushing back the top portion 123b. As a result, it becomes easy to maintain a state in which the top portion 123b fits into the second bus bar 200. Furthermore, since the contact area between the second bus bar 200 and the first bus bar 120 increases as the part of the second bus bar 200 fits into the bottom side of the concave groove 123a, the electrical connection resistance can be reduced.

Alternatively to the present embodiment, the width of the top portion 123b may be equal to or smaller than the width of the concave-groove bottom portion 123a1.

Moreover, the width of the top portion 123b is preferably smaller than the width of the concave groove 123a at the opening portion of the concave groove 123a. As the width of the top portion 123b is sufficiently small, the top portion 123b can easily fit into the second bus bar 200 in the step for joining to be described below.

In the present embodiment, the first bus bar 120 includes a through hole 121 that opens at a contact portion 122. The through hole 121 also opens at a rear surface 127 (see FIG. 1A) that is located on a side opposite in front and back to the contact portion 122 of the first bus bar 120. In other words, a penetrating direction of the through hole 121 in the present embodiment coincides with the thickness direction of the first bus bar 120. In addition, the penetrating direction of the through hole 121 also coincides with an axial direction of the shaft member 140 to be described below. The through hole 121 is defined by the peripheral wall surface 121b, which is also a part of the outer surface of the first bus bar 120. A penetrating direction of the through hole 121 is preferably a direction orthogonal to the longitudinal direction (z-axis direction) of the first bus bar 120. Specifically, as shown in FIG. 4, the penetrating direction of the through hole 121 is preferably a direction equal to the direction (y-axis direction) in which the first bus bar 120 and the contacting member (second bus bar 200) coming in contact with the first bus bar 120 overlap.

In the present embodiment, the shape of the through hole 121 is circular as viewed in the penetrating direction of the through hole 121, but is not limited thereto. Such a shape may be a polygonal shape such as a rectangular shape, or may be an elliptical shape other than the circular shape.

The electronic component 100 includes the shaft member 140 that is inserted into the through hole 121. The shaft member 140 is a long member including the shaft portion 142 that is inserted into the through hole 121 in the first bus bar 120 and a hole provided in the second bus bar 200. As shown in FIG. 4, the shaft member 140 in the present embodiment is a bolt. In the electric device 1 to be described below, the first bus bar 120 and the second bus bar 200 are joined and maintained by the shaft member 140. One end of the shaft member 140 (an end on the side of the shaft head portion 141 to be described below) is arranged in the through hole 121, and the shaft member 140 is erected in the through hole 121. Here, that the shaft member 140 is erected in the through hole 121 means that the shaft member 140 is inserted into the through hole 121 and the extending direction (axial direction) of the shaft member 140 is a direction intersecting with the contact portion 122. Preferably, the extending direction of the shaft member 140 is a direction perpendicular to the contact portion 122.

The unevenness region 122a is arranged around the shaft member 140 as viewed in the axial direction of the shaft member 140. That the unevenness region 122a is arranged around the shaft member 140 as viewed in the axial direction of the shaft member 140 means that the unevenness region 122a is formed on a part of the contact portion 122 close to the shaft member 140 (through hole 121). In other words, the shortest distance along the contact portion 122 between the shaft member 140 and the unevenness region 122a (a distance between the peripheral wall surface of the through hole 121 and the peripheral edge of the unevenness region 122a as viewed in the axial direction of the shaft member 140) is small. The shortest distance is equal to the width of the inner peripheral portion 122c to be described below. More specifically, the shortest distance is preferably smaller than an overhanging dimension of a shaft head portion 141 to be described below. Here, the overhanging dimension of the shaft head portion 141 indicates a height of an outer peripheral edge of the shaft head portion 141 based on a peripheral surface of the shaft portion 142. Alternatively, the shortest distance is preferably smaller than the radius of the through hole 121. More preferably, the shortest distance is 0. When the unevenness region 122a is arranged around the shaft member 140 in this manner, the shaft member 140 (particularly, the shaft head portion 141) can sufficiently apply stress for the unevenness structure 123, which will be described below, to fit into the contacting member (for example, the second bus bar 200).

In the present embodiment, the unevenness region 122a is formed so as to completely surround the periphery of the shaft member 140 as viewed in the axial direction of the shaft member 140. In other words, the unevenness region 122a is formed omnidirectionally on an outer side in a diameter directions of the shaft member 140. Here, the diameter direction of the shaft member 140 is a direction from an axial center of the shaft member 140 toward the peripheral surface of the shaft member 140. Alternatively to the present embodiment, the unevenness region 122a may be formed on a part of the outer side in the diameter direction of the shaft member 140.

As shown in FIG. 1B, the contact portion 122 includes an inner peripheral portion 122c located closer to the shaft member 140 than the unevenness region 122a. The inner peripheral portion 122c is a partial surface region of the contact portion 122. In the present embodiment in which the contact portion 122 is arranged to surround the periphery of the shaft member 140 as viewed in the axial direction of the shaft member 140, the inner peripheral portion 122c is a surface region that occupies a side closer to the shaft member 140 than an inner peripheral edge of the unevenness region 122a as viewed in the axial direction of the shaft member 140. In other words, in the present embodiment, as viewed in the axial direction of the shaft member 140, the inner peripheral portion 122c is arranged to surround the periphery of the shaft member 140, and the unevenness region 122a is arranged to surround the inner peripheral portion 122c. More specifically, the inner peripheral portion 122c is a region located between a two-dot chain line IV, which is the inner peripheral edge of the unevenness region 122a shown in FIG. 1B, and the peripheral wall surface 121b. Alternatively to the present embodiment, when the unevenness region 122a is formed only in a part in the diameter direction of the shaft member 140 and is not formed in the other part in the diameter direction, the inner peripheral portion 122c is a region located between the peripheral wall surface 121b of the through hole 121 and the unevenness region 122a as viewed in the axial direction of the shaft member 140.

As shown in FIG. 3A, the inner peripheral portion 122c is flat. That the inner peripheral portion 122c is flat means that the unevenness structure 123 is not formed on the inner peripheral portion 122c. The inner peripheral portion 122c being flat includes the inner peripheral portion 122c being a curved surface that expands toward a protruding outer side of the first bus bar 120 or is recessed toward a protruding inner side. The inner peripheral portion 122c is preferably planar.

Since the inner peripheral portion 122c is flat, in a step for joining to be described below, the inner peripheral portion 122c abuts against a facing surface 210 of a second bus bar 200, and thus a positional relation between the first bus bar 120 and the second bus bar 200 can be aligned. Specifically, at the beginning or in the course of the process of allowing the second bus bar 200 and the first bus bar 120 to come into pressure contact with each other, the inner peripheral portion 122c comes into surface contact with the facing surface 210, whereby the contact portion 122 of the first bus bar 120 and the facing surface 210 of the second bus bar 200 are arranged parallel to each other.

In the present embodiment, as will be described below, the first bus bar 120 expands and is curved in the protruding direction of the unevenness structure 123. More specifically, a part close to the shaft member 140 expands most in the protruding direction. For this reason, a virtual plane II (a surface indicated by a tow-dot chin line in FIGS. 3A and 3B), which is a surface connecting protruding ends 123b of the protrusion portion 123e and will be described below, expands and is curved in the protruding direction of the unevenness structure 123. Specifically, a part of the virtual plane II close to the shaft member 140 expands most in the protruding direction. In other words, the virtual plane II shown in FIGS. 3A and 3B is arranged slantly upward from a lower left to an upper right in the drawings. Virtual planes I and II shown in FIGS. 3A and 3B, respectively, are surfaces that are connected to each other.

In FIG. 2, the curved shape of the first bus bar 120 is not shown, and the first bus bar 120 is shown as being flat.

The curved shape of the first bus bar 120 (the curved shape of the virtual plane II) may be formed in a way such as cutting at the time of forming an outer shape of the first bus bar 120 or applying stress. Alternatively, the shape may be formed when the shaft member 140 is inserted into the through hole 121 by pressing.

The contact portion 122 includes the outer peripheral portion 122b arranged around the unevenness region 122a.

The outer peripheral portion 122b is a partial surface region adjacent to the unevenness region 122a in the contact portion 122, and is a region where the unevenness structure 123 is not formed. In other words, the outer peripheral portion 122b is a region of which surface is formed flatter than the unevenness region 122a. Moreover, the outer peripheral portion 122b is a region located outward of the unevenness region 122a as viewed in the diameter direction of the shaft member 140. For example, the outer peripheral portion 122b is a partial surface region having a predetermined width along a part of the outer edge of the unevenness region 122a. In the present embodiment in which the unevenness region 122a is formed to surround the periphery of the shaft member 140 as viewed in the axial direction of the shaft member 140, the outer peripheral portion 122b is a region that is formed to surround the periphery of the unevenness region 122a as viewed in the axial direction and has a predetermined width in the diameter direction of the shaft member 140. In other words, the outer peripheral portion 122b is a region located between the outer peripheral edge of the unevenness region 122a indicated by a two-dot chain line III shown in FIG. 1B and the side end surface of the cover portion 130. Alternatively to the present embodiment, when the unevenness region 122a is formed only in a part in the diameter direction of the shaft member 140, the outer peripheral portion 122b is a region formed outside the unevenness region 122a in the part in the diameter direction of the shaft member 140.

In the present embodiment, the inner peripheral portion 122c protrudes farther in the protruding direction of the unevenness structure 123 than the outer peripheral portion 122b. The protruding direction of the unevenness structure 123 is a direction from the height of the concave portion (the height of the concave-groove bottom portion 123a1) toward the height of the top portion 123b in the unevenness structure 123. The protruding direction coincides with a direction (y direction) from the contact portion 122 toward the outside of the first bus bar 120, among directions orthogonal to the contact portion 122 (unevenness region 122a).

Since the inner peripheral portion 122c protrudes farther in the protruding direction of the unevenness structure 123 than the outer peripheral portion 122b, inner peripheral portion 122c abuts against the second bus bar 200 in the step for joining to be described below before the outer peripheral portion 122b abuts against the second bus bar 200. The inner peripheral portion 122c continuously comes into pressure contact with the second bus bar 200 until the outer peripheral portion 122b begins to come into pressure contact with the second bus bar 200. In this manner, the inner peripheral portion 122c is deformed by the stress applied from the second bus bar 200. Specifically, a part of the inner peripheral portion 122c comes into pressure contact with the shaft member 140 in a radially inward direction (a direction from a peripheral edge of the shaft member 140 toward an axial center) of the shaft member 140. Thus, a pressure-contact force between the shaft member 140 and the peripheral wall surface 121b of the through hole 121 increases, and the shaft member 140 and the first bus bar 120 are fixed more firmly.

Alternatively to the present embodiment, the inner peripheral portion 122c and the outer peripheral portion 122b may be arranged at the same height in the protruding direction of the unevenness structure 123. In other words, the inner peripheral portion 122c and the outer peripheral portion 122b may be arranged on the same plane. With such a configuration, when the first bus bar 120 and the second bus bar 200 come into pressure contact with each other in the step for joining to be described below, the first bus bar 120 and the second bus bar 200 come into contact with each other at the substantially same time at both a part of the contact portion 122 on the side close to the shaft member 140 and a part of the contact portion 122 on the peripheral edge side. Thus, the first bus bar 120 and the second bus bar 200 can come into pressure contact with each other while relative positions are aligned.

Alternatively to the present embodiment, the outer peripheral portion 122b may protrude farther in the protruding direction of the unevenness structure 123 than the inner peripheral portion 122c.

As shown in FIGS. 3A to 3B, the unevenness structure 123 includes a plurality of protrusion portions 123e. A protruding end 123b (also a top portion 123b) of the protrusion portion 123e protrudes farther in the protruding direction of the unevenness structure 123 than the inner peripheral portion 122c. One protrusion portion 123e may protrude farther in the protruding direction of the unevenness structure 123 than the almost whole of the inner peripheral portion 122c. As described above, the virtual plane II is arranged slantly upward from a lower left to an upper right in the drawings. Accordingly, in the present embodiment, the protruding end 123b of the protrusion portion 123e (for example, the protrusion portion 123e on the right side in FIG. 3A) in the vicinity of the inner peripheral portion 122c protrudes farther in the protruding direction than the inner peripheral portion 122c. The other protrusion portions 123e may or may not protrude in the protruding direction from the inner peripheral portion 122c. In other words, the inner peripheral portion 122c may or may not protrude in the protruding direction from the other protrusion portions 123e. In the present embodiment, the inner peripheral portion 122c protrudes in the protruding direction of the unevenness structure 123 from the protrusion portions 123e arranged near the outer peripheral portion 122b.

Alternatively to the present embodiment, the protruding ends 123b of all the protrusion portions 123e in the unevenness structure 123 may protrude in the protruding direction of the unevenness structure 123 from the almost whole of the inner peripheral portion 122c.

In the present embodiment, the protruding end 123b of the protrusion portion 123e protrudes in the protruding direction of the unevenness structure 123 from the outer peripheral portion 122b.

Since the protruding end 123b of the protrusion portion 123e protrudes farther in the protruding direction of the unevenness structure than the inner peripheral portion 122c, the protruding end 123b of the protrusion portion 123e abuts against the second bus bar 200 in the step for joining to be described below before the inner peripheral portion 122c abuts against the second bus bar 200. For this reason, the protrusion portion 123e including the protruding end 123b easily fits into the second bus bar 200 in the step for joining.

In the present embodiment, the concave-groove bottom portion 123a1 of the unevenness structure 123 is recessed in a direction opposite to the protruding direction (y direction) of the unevenness structure 123, relative to the outer peripheral portion 122b. As a result, the second bus bar 200 can be favorably fitted into the interior of the first bus bar 120 (i.e., into the interior of the concave groove 123a).

In the present embodiment, the depth dimension of the concave-groove bottom portion 123a1 with reference to the outer peripheral portion 122b (i.e., the dimension in the protruding direction of the unevenness structure 123) is greater than the protruding dimension of the top portion 123b with reference to the outer peripheral portion 122b (i.e., the dimension in the protruding direction of the unevenness structure 123). As a result, the second bus bar 200 can be favorably fitted into the interior of the first bus bar 120.

Alternatively, in place of the present embodiment, the depth dimension of the concave-groove bottom portion 123a1 with reference to the outer peripheral portion 122b (i.e., the dimension in the protruding direction of the unevenness structure 123) may be smaller than the protruding dimension of the top portion 123b with reference to the outer peripheral portion 122b (i.e., the dimension in the protruding direction of the unevenness structure 123). In this case, the top portion 123b of the first bus bar 120 can be easily fitted into the second bus bar 200.

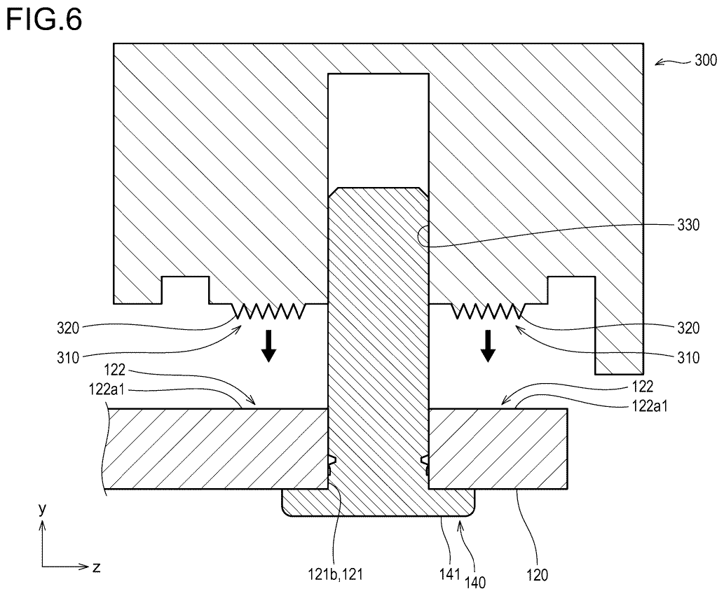

Alternatively to the present embodiment, the inner peripheral portion 122c may protrude farther in the protruding direction of the unevenness structure 123 than the protruding end 123b of the protrusion portion 123e. In this case, the outer peripheral portion 122b may protrude farther in the protruding direction of the unevenness structure 123 than the protruding end 123b of the protrusion portion 123e, and the protruding end of the protrusion portion 123e may protrude farther in the protruding direction than the outer peripheral portion 122b. Since the inner peripheral portion 122c protrudes farther in the protruding direction of the unevenness structure 123 than the protruding end 123b of the protrusion portion 123e, the inner peripheral portion 122c abuts against the facing surface of the second bus bar 200 before the protruding end 123b abuts in the step for joining to be described below. Thus, as described above, the inner peripheral portion 122c is deformed by the stress from the second bus bar 200, and the pressure-contact force between the shaft member 140 and the peripheral wall surface 121b of the through hole 121 increases, whereby the shaft member 140 and the first bus bar 120 are fixed more firmly. Furthermore, since the flat inner peripheral portion 122c abuts against the facing surface of the second bus bar 200 before the protruding end 123b abuts in the step for joining, the relative positions of the first bus bar 120 and the second bus bar 200 can be aligned as described above. In a manufacturing method to be described below, the shape and dimensions of a relief hole 330 (see FIG. 6) provided in the pressing member 300 (see FIG. 6) are made larger than the shape and dimensions of the transverse section of the shaft member 140, and thus the inner peripheral portion 122c can protrude farther in the protruding direction of the unevenness structure 123 than the protrusion portion 123e.

Alternatively to the present embodiment, the inner peripheral portion 122c and the protruding end 123b may be arranged in the protruding direction at approximately the same height in the unevenness structure 123.

As described above, the unevenness structure 123 includes a bottomed concave portion 123a (concave groove 123a). As shown in FIGS. 3A and 3B, a depth dimension of a part of the concave portion 123a is larger than a depth dimension of another part of the concave portion 123a arranged on the side close to the peripheral edge (outer peripheral edge) of the unevenness region 122a (hereinafter, also simply referred to as a peripheral edge side). Here, the depth of the concave portion 123a is a depth dimension of a bottom portion (concave-groove bottom portion 123a1) based on the virtual plane II connecting the protrusion ends 123b of the plurality of protrusion portions 123e. As described above, in the present embodiment, the virtual line II is arranged slantly from a lower left to an upper right as shown in FIGS. 3A and 3B. At this time, the depth of the concave portion 123a may be the maximum depth dimension, the minimum depth dimension, or an average depth dimension of the bottom portion of the concave portion 123a based on the virtual plane II.

In the present embodiment, the concave portion 123a refers to a concave groove 123a. In the present embodiment, the depth dimension of the concave portion 123a can be regarded as a depth dimension from an upper end (one end continuing to the top portion 123b) of one of a pair of concave-groove wall portions 123a2, which define the concave groove 123a, to the concave-groove bottom portion 123a1.

That the depth dimension of the part of the concave groove 123a is larger than the depth dimension of another part of the concave groove 123a on the outer peripheral edge side means that a depth dimension of a partial length region in the concave groove 123a is larger than a depth dimension of another partial length region that is arranged closer to the outer peripheral edge side than the partial length region. Alternatively, that the depth dimension of the part of the concave groove 123a is larger than the depth dimension of another part of the concave groove 123a on the outer peripheral edge side means that a depth dimension of a partial length region in one concave groove 123a is larger than a depth dimension of a partial length region of another concave groove 123a arranged closer to the outer peripheral edge side than the partial length region.

That the depth dimension of the part of the concave portion 123a is larger than the depth dimension of another part on the outer peripheral edge side means that the protruding dimension of one protrusion portion 123e is larger than the protruding dimension of another protrusion portion 123e on the outer peripheral edge side. Here, the protruding dimension of the protrusion portion 123e is a height of the protruding end 123b based on a height of a base end of the protrusion portion 123e in the protruding direction of the unevenness structure 123 (a height equal to that of the concave-groove bottom portion 123a1).

As will be described below, the first bus bar 120 and the second bus bar 200 are fixed by being interposed between the shaft head portion 141 and the nut 143. For this reason, the region of the unevenness region 122a on the side close to the shaft member 140 strongly comes into pressure contact with the second bus bar 200 rather than the region on the outer peripheral edge side from the region of the unevenness region 122a. Therefore, the depth dimension of the concave groove 123a becomes larger in the region of the unevenness region 122a closer to the shaft member 140, and thus the second bus bar 200 can be fitted deep into the concave portion 123a in the region where the pressure-contact force between the first bus bar 120 and the second bus bar 200 is strong.

As described above, a part of the virtual plane II on the side close to the shaft member 140 expands most in the protruding direction of the unevenness structure 123. In other words, the protruding end 123b of one protrusion portion 123e protrudes farther in the protruding direction of the unevenness structure 123 than the protruding end 123b of another protrusion portion 123e on the outer peripheral edge side. Furthermore, the bottom portions of the concave portions 123a are arranged at a uniform height (a height represented by the virtual plane I) in the protruding direction of the unevenness structure 123. In other words, the concave-groove bottom portions 123a1 are at the same height in the protruding direction over the entire length region of the concave grooves 123a, and the heights of the concave-groove bottom portions 123a1 of two adjacent concave grooves 123a are the same in the protruding direction.

Since the protruding end 123b of one protrusion portion 123e protrudes farther in the protruding direction of the unevenness structure 123 than the protruding end 123b of another protrusion portion 123e on the outer peripheral edge side, the protrusion portion 123e arranged on the side of the shaft member 140 can be fitted into the second bus bar 200 in order in the step for joining to be described below.

Alternatively to the present embodiment, the virtual plane II may be a plane perpendicular to the axial direction of the shaft member 140. In other words, the heights of the protruding ends of the plurality of protrusion portions 123e may be the same as each other in the protruding direction of the unevenness structure 123.

As shown in FIG. 5B, the outer surface of the first bus bar 120 includes the adjacent portion 124. The adjacent portion 124 is adjacent to the outer peripheral portion 122b (contact portion 122) as viewed in the axial direction of the shaft member 140, and is covered by the cover portion 130. A step is formed between the outer peripheral portion 122b and the adjacent portion 124 to rise from the outer peripheral portion 122b toward the adjacent portion 124. In other words, the adjacent portion 124 protrudes in the protruding direction of the unevenness structure 123 from the outer peripheral portion 122b, and a height in the protruding direction of a boundary between the adjacent portion 124 and the outer peripheral portion 122b changes suddenly. A surface standing up with respect to the contact portion 122 at the boundary between the adjacent portion 124 and the outer peripheral portion 122b is referred to as a step surface 124a of the step (hereinafter, simply referred to as a step surface 124a). The step surface 124a is arranged so as to intersect with the contact portion 122, and is preferably arranged perpendicular to the contact portion 122. The step surface 124a is continuous with a side end surface (inward end surface 131) of the cover portion 130. The inward end surface 131 is a surface of the side end surface of the cover portion 130 that faces of a peripheral surface (particularly, a shaft portion 142; see FIG. 2) of the shaft member 140. That the step surface 124a is continuous with the inward end surface 131 means that there is substantially no step between the step surface 124a and the inward end surface 131. Specifically, it is preferable that there is substantially no step between an inner end of the inward end surface 131 (one end on an inner side in the protruding direction of the unevenness structure 123) and an outer end of the step surface 124a (one end on an outer side in the protruding direction of the unevenness structure 123). For example, a step between the step surface 124a and the inward end surface 131 is preferably smaller than the width of concave-groove bottom portion 123a1. In addition, the step surface 124a and the inward end surface 131 may be arranged such that the inner end of the inward end surface 131 and the outer end of the step surface 124a are close to each other and the step surface 124a and the inward end surface 131 intersect with each other.

Since the inward end surface 131 is continuous with the step surface 124a, the second bus bar 200 (see FIG. 6) can be easily arranged in a desired range (contact portion 122) on the outer surface of the first bus bar 120 in the step for joining.

The first bus bar 120 includes a conductor portion 125 and an oxide film 126. The oxide film 126 covers the conductor portion 125. The conductor portion 125 is a portion of the first bus bar 120 which is made of a material such as a metal containing copper with good conductivity. The oxide film 126 is a thin film made of an oxide of the metal used for the conductor portion 125 and formed on a surface of the conductor portion 125. The oxide film 126 is insulating or has a higher resistance than the conductor portion 125. The oxide film 126 covers at least a part of the conductor portion 125. In the first bus bar 120 that is not joined to the second bus bar 200, the oxide film 126 covers at least the whole of the contact surface 122. Over the entire area of the first bus bar 120 that is not joined to the second bus bar 200, it is preferable that the thickness of the oxide film 126 is approximately uniform. In FIGS. 3A, 3B, 5A, and 5B, the thickness of the oxide film 126 is depicted to be larger than the actual thickness of the oxide film for convenience.

### (Bus Bar)

The first bus bar 120 may be provided as a single bus bar without including the main body 110. FIG. 4 is a cross-sectional view showing an example of the electric device 1. As described above, a part of the outer surface of the first bus bar 120 is covered by the cover portion 130. Another part of the outer surface is formed with the unevenness structure 123.

### (Electronic Device)

The electronic component 100 of the present embodiment can be provided as an electric device 1 including the electronic component 100. The electric device 1 includes the electronic component 100 and the second bus bar (second bus bar 200). The second bus bar 200 contacts with the first bus bar 120. Specifically, the second bus bar 200 is in contact with the contact portion 122 at a facing surface 210 facing the contact portion 122. As shown in FIGS. 3A and 3B, the top portion 123b, which is the leading end protruding in the unevenness structure 123, fits into the second bus bar 200.

The electric device 1 is a device including the electronic component 100, and the electric device 1 is for in-vehicle use in the present embodiment. The electric device 1 may include a closed electronic circuit by itself, or the electric device 1 may be electrically connected to another electric device.

The second bus bar 200 is a bus bar electrically connected to the first bus bar 120. The second bus bar 200 may be a bus bar used to be connected to another electric device electrically connected to the electric device 1, or may be a bus bar used to be connected to another electronic component included in the electric device 1. In the present embodiment, the second bus bar 200 is a rod-like bus bar as shown in FIG. 4. The axial direction of the second bus bar 200 approximately coincides with the axial direction of the shaft member 140.

The facing surface 210 in the second bus bar 200 refers to a partial surface region on the outer surface of the second bus bar 200, and is a surface including a portion that is in contact with or scheduled to come into contact with the first bus bar 120. The facing surface 210 may include only a portion or the whole of the surface that is in contact with or scheduled to come into contact with the first bus bar 120. The facing surface 210 may further include a partial surface region that is arranged near a surface that is in contact with or scheduled to come into contact with the first bus bar 120, and that is not in contact with or not scheduled to come into contact with the first bus bar 120.

That the part (for example, the top portion 123b) of the first bus bar 120 is fitted into the second bus bar 200 means that the part is arranged within the maximum outer shape of the second bus bar 200. The maximum outer shape of the second bus bar 200 is a three-dimensional shape including the inside of large and small concave portions (not limited to the concave portions in the unevenness structure 123) formed on the surface of the second bus bar 200.

The part of the first bus bar 120, which fits into the second bus bar 200, is not limited to the top portion 123b. It is preferable that not only the top portion 123b but also a part of the leading end side (on the side of the top portion 123b) of the concave-groove wall portion 123a2 fits into the second bus bar 200. More preferably, as shown in FIG. 5A or 5B, at least half of the leading end side of the concave-groove wall portion 123a2 fits into the second bus bar 200. In other words, a part of a bottom side of the concave-groove wall portion 123a2 and the concave-groove bottom portion 123a1 are arranged outside the second bus bar 200. Alternatively to the present embodiment, the whole of the concave-groove wall portion 123a2 may fit into the second bus bar 200. In addition, the parts fitting into the second bus bar 200 (the top portion 123b and the part of the concave-groove wall portion 123a2 in the present embodiment) are in surface contact with the second bus bar 200.

The top portion 123b fits into the second bus bar 200 in this manner, whereby the contact area between the second bus bar 200 and the first bus bar 120 can be increased compared to a case where the top portion 123b does not fit into the second bus bar 200. This makes it possible to reduce the electrical connection resistance at the contact surface between the second bus bar 200 and the first bus bar 120.

As shown in FIGS. 5A and 5B, even in the electric device 1 in which the second bus bar 200 is joined to the first bus bar 120, the first bus bar 120 includes the conductor portion 125 and the oxide film 126. The oxide film 126 covers at least a part of the conductor portion 125. In the electric device 1 in which the first bus bar 120 and the second bus bar 200 are joined to each other, a range of the conductor portion 125 covered by the oxide film 126 differs from a range of the conductor portion 125 covered by the oxide film 126 in the electronic component 100 in which the second bus bar 200 is not joined. Specifically, the outer peripheral portion 122b is a covering portion that is covered with the oxide film 126. On the other hand, at least a part of the unevenness structure 123 is an exposed portion that is exposed from the oxide film 126. The exposed portion is buried in the second bus bar 200.

The covering portion is a partial surface region on the outer surface of the first bus bar 120 where the oxide film 126 is formed and the conductor portion 125 is not exposed. The exposed portion is a partial surface region on the outer surface of the first bus bar 120 where the oxide film 126 is not formed and the conductor portion 125 is exposed. A part or whole of the surface of the unevenness structure 123 is an exposed portion. In the present embodiment, only a part of the surface of the unevenness structure 123 is an exposed portion, and the other part thereof is a covering portion.

That the outer peripheral portion 122b is the covering portion means that at least a part of the outer peripheral portion 122b is the covering portion. Preferably, almost the whole of the outer peripheral portion 122b is the covering portion as in the present embodiment.

As will be described in detail below, in the present embodiment, a part of the concave-groove wall portion 123a2 is the exposed portion, and the other remaining parts on the outer surface of the first bus bar 120 are the covering portions that are covered with the oxide film 126.

In the electric device 1 of the present embodiment in which the first bus bar 120 and the second bus bar 200 are joined to each other, at least a part of the exposed portion in the first bus bar 120 fits into the second bus bar 200. In the present embodiment, almost the whole of the exposed portion fits into the second bus bar 200. At the exposed portion fitting into the second bus bar 200, the conductor portion 125 of the first bus bar 120 is in contact with the second bus bar 200.

Generally, the bus bar is plated with a metal such as nickel to prevent the formation of the oxide film, improve electrical connection, and protect the conductor portion. Since a part of the surface of the unevenness structure 123 is the exposed portion in which the conductor portion 125 is exposed, the first bus bar 120 and the second bus bar 200 come into contact with each other at the exposed portion and are electrically connected to each other. This allows good conductivity to be maintained without metal plating, making it possible to easily manufacture the first bus bar 120. In addition, the conductor portion 125 is exposed in the unevenness structure 123 that is electrically connected with the second bus bar 200, and the outer surfaces of the other portions in the first bus bar 120 are covered with the oxide film 126, whereby the conductor portions 125 are protected in such portions.

As shown in FIGS. 3A, 3B, 5A, and 5B, the concave-groove wall portion 123a2 is arranged obliquely with respect to the outer peripheral portion 122b. In the electric device 1 of the present embodiment, as shown in FIGS. 5A and 5B, at least a part of the concave-groove wall portion 123a2 is an exposed portion being in contact with the second bus bar 200.

In the present embodiment, a part of the concave-groove wall portion 123a2 on the side of the top portion 123b is the exposed portion, and a part thereof on the side of the concave-groove bottom portion 123a1 is the covering portion. However, the oxide film 126 may remain locally on the part of the concave-groove wall portion 123a2 on the side of the top portion 123b to form the covering portion.

In the present embodiment, the first bus bar 120 is in contact with the second bus bar 200 at the top portion 123b and the concave-groove wall portion 123a2 (particularly, the part on the side of the top portion 123b), but the concave-groove bottom portion 123a1 and the second bus bar 200 are spaced apart from each other. In other words, a gap portion is provided inside concave groove 123a in the vicinity of the concave-groove bottom portion 123a1, the gap being defined by the concave-groove bottom portion 123a1, the concave-groove wall portion 123a2, and the second bus bar 200. At least a part of the concave-groove bottom portion 123a1 spaced apart from the second bus bar 200 is a covering portion.

As shown in FIG. 3B, since the concave-groove wall portion 123a2 is arranged obliquely with respect to the outer peripheral portion 122b or the adjacent portion 124, the concave-groove wall portion 123a2 is arranged obliquely in the thickness direction in which the second bus bar 200 comes into pressure contact with the first bus bar 120 in the step for joining to be described below. Thus, the oxide film 126 on the concave-groove wall portion 123a2 is easily scraped off by the second bus bar 200, compared to a case where the concave-groove wall portion 123a2 is orthogonal to the outer peripheral portion 122b (that is, stands vertically) or is parallel to the outer peripheral portion 122b.

Furthermore, compared to a case where the concave-groove wall portion 123a2 is orthogonal to the outer peripheral portion 122b or is parallel to the outer peripheral portion 122b, when the concave-groove wall portion 123a2 is oblique with respect to the outer peripheral portion 122b, the contact area between the concave-groove wall portion 123a2 and the second bus bar 200 increases when the top portion 123b is inserted into the second bus bar 200 to the same depth. This makes it possible to reduce the electrical connection resistance.

In the present embodiment, at least a part of the top portion 123b is a covering portion. The thickness of the oxide film 126 at the top portion 123b is preferably smaller than the thickness of the oxide film 126 at the concave-groove bottom portion 123a1. This makes it possible to improve the electrical connection between the first bus bar 120 and the second bus bar 200 at the top portion 123b. Alternatively to the present embodiment, the whole of the top portion 123b may be an exposed portion in which the conductor portion 125 is exposed.

Alternatively to the present embodiment, the oxide film 126 may remain on the surface of the unevenness structure 123, and the entire region of the unevenness structure 123 may be a covering portion that is covered with the oxide film 126. In this case, the thickness of the oxide film 126 may be approximately uniform or may not be uniform in the unevenness structure 123. For example, the oxide film 126 fitting into the second bus bar 200 may be thinner than the oxide film 126 arranged outside the second bus bar 200. For example, the thickness of the oxide film 126 covering a part of the concave-groove wall portion 123a2 on the side of the top portion 123b may be smaller than the thickness of the oxide film 126 covering the concave-groove bottom portion 123a1.

As shown in FIG. 5A or 5B, the second bus bar 200 includes a second conductor portion 220 and a second oxide film 230 that covers the second conductor portion 220. A part of the outer surface of the second bus bar 200 coming into contact with the first bus bar 120 (a part of the facing surface 210) is a second exposed portion in which the second conductor portion 220 is exposed. The other part of the outer surface of the second bus bar 200 is a second covering portion that is covered with the second oxide film 230.

The second conductor portion 220 is a portion of the second bus bar 200 which is made of a material such as copper having good conductivity. The second oxide film 230 is a thin film formed on the surface of the second conductor portion 220 by an oxide of the metal in the second conductor portion 220. The second oxide film 230 is insulating or has a higher resistance than the second conductor portion 220. The second oxide film 230 covers at least a part of the second conductor portion 220. The second oxide film 230 preferably covers substantially the whole of the second conductor portion 220. Here, that the second oxide film 230 covers substantially the whole of the second conductor portion 220 means that a part of the facing surface 210 has a minute surface region (a second exposed portion to be described below) where the conductor portion 125 is exposed without being covered with the oxide film 126.

A part or whole of a portion of the facing surface 210 being in contact with the first bus bar 120 is the second exposed portion in which the second conductor portion 220 is exposed, but a part of the facing surface 210 not being in contact with the first bus bar 120 may be a second covering portion that is covered with the second oxide film 230. Specifically, a part of the facing surface 210 facing and being in contact with the concave-groove wall portion 123a2 is the second exposed portion. Moreover, a part of the facing surface 210 facing and being in contact with the top portion 123b or the outer peripheral portion 122b is the second covering portion. Furthermore, a part of the facing surface 210 facing and spaced apart from the concave-groove bottom portion 123a1 is also the second covering portion. A thickness of the second oxide film 230 in the second covering portion facing and space apart from the concave-groove bottom portion 123a1 is preferably larger than a thickness of the second oxide film 230 in the part facing and being in contact with the top portion 123b or the outer peripheral portion 122b.

A part of the outer surface of the second bus bar 200 coming into contact with the first bus bar 120 is regarded as the second exposed portion, and the other parts are covered with the second oxide film 230, whereby plating of the second bus bar 200 cannot be necessary.

As described above, the joining between the first bus bar 120 and the bus bar 200 is maintained by the shaft member 140. The shaft member 140 is a long member including the shaft portion 142 that is inserted into the through hole 121 of the first bus bar 120 and the hole provided in the second bus bar 200. As shown in FIG. 6, the shaft member 140 in the present embodiment is a bolt. The shaft member 140 includes the shaft head portion 141 that has a larger diameter than the shaft portion 142, which is inserted into the bus bars, at one end of the shaft portion 142.

In the present embodiment, the shaft portion 142 is provided with a spiral thread groove, and the second bus bar 200 is provided with a female thread portion (a bottomed concave portion or a through hole) corresponding to the shape and dimensions of the shaft portion 142 with the thread groove. The shaft portion 142 is attached to the female thread portion of the second bus bar 200. In a state in which the second bus bar 200 and the first bus bar 120 are joined to each other, the shaft head portion 141 bias the first bus bar 120 toward the second bus bar 200, and the first bus bar 120 and the second bus bar 200 are joined to each other. The shaft portion 142 comes into pressure contact with the peripheral wall surface that defines the bottomed concave portion or the through hole provided in the second bus bar 200, and thus first bus bar 120 and the second bus bar 200 may be fixed to each other. Alternatively, the first bus bar 120 and the second bus bar 200 may be fixed to each other by joining the shaft portion 142 to the peripheral wall surface, which defines the bottomed concave portion or the through hole provided in the second bus bar 200, with an adhesive or the like.

Alternatively to the present embodiment, the second bus bar 200 may be a plate-like bus bar that extends in approximately the same direction as the extending direction of the first bus bar 120. In this case, the first bus bar 120 and the second bus bar 200 may be fixed to each other by inserting the shaft member 140 into the through hole 121 of the first bus bar 120 and the through hole provided in the second bus bar 200 and tightening a nut from the other end opposite to the shaft head portion 141 of the shaft member 140.

The shaft member 140 may not include the shaft head portion 141. In this case, for example, after the shaft portion 142 is inserted into the through hole 121, the one end of the shaft member 140 may be fixed to a part of the first bus bar 120 by welding or the like. Alternatively, the one end of the shaft member 140 may be fixed to, for example, a wall portion of another member by welding or the like.

### (Method for Manufacturing Electronic Component)

A method for manufacturing the electronic component 100 of the present embodiment (hereinafter, sometimes referred to as the present method) will be described below.

FIG. 6 is a schematic cross-sectional view showing a course of a step for molding of the present method.

First, an overview of the present method will be described.

The electronic component 100 manufactured by the present method includes a main body 110 including an electronic element 111, a bus bar (first bus bar 120) that is electrically connected to the electronic element 111, and a cover portion 130 that covers a part (at least an adjacent portion 124) of the outer surface of the first bus bar 120. Details of the electronic component 100 will be described below.

The present method includes a step for molding. In the step for molding, a cover material is placed on a covered portion to mold the cover portion 130.

Subsequently, the present method will be described in detail.

As shown in FIG. 6, a pressing member 300 including a pressing surface 310 with unevenness is used in the step for molding. The pressing member 300 refers to a member that is pressed against a conductive member (hereinafter, the conductive member may be referred to as the first bus bar 120) for forming the first bus bar 120. As will be described below, when the cover portion 130 (see FIG. 4) is injection-molded as in the present embodiment, the pressing member 300 may be a die for injection molding. Alternatively, the pressing member 300 may be a masking member that covers and protects the contact portion 122 as will be described below.

In the step for molding, the cover portion 130 (see FIG. 4) is molded, and the unevenness structure 123 (see FIG. 4) is formed in the first bus bar 120. The cover portion 130 is molded in the step for molding, and the unevenness structure 123 is formed in the first bus bar 120 at the same time, whereby it is not necessary to have a step of embossing the unevenness structure 123 on the first bus bar 120 separately from the step for molding, making it possible to easily manufacture the electronic component 100.

Specifically, the pressing member 300 covers the contact portion 122 such that the pressing surface 310 comes into pressure contact with a predetermined part of the outer surface of the first bus bar 120, the part being an area where no cover material is disposed, and the cover material is placed around the pressing member 300 to mold the cover portion 130. The predetermined part of the outer surface of the first bus bar 120 coming into pressure contact with the pressing surface 310 is a surface region including a part or whole of the contact portion 122. In other words, the predetermined part is a surface region including a scheduled unevenness region forming portion 122a1 where the unevenness region 122a is scheduled to be formed. The pressing surface 310 comes into pressure contact with the outer surface of the first bus bar 120 with a sufficient force to such an extent that the unevenness of the pressing surface 310 is transferred to the outer surface of the first bus bar 120 and to such an extent that no cover material substantially invades between the pressing surface 310 and the first bus bar 120. Specifically, the pressing member 300 comes into pressure contact with the first bus bar 120 in a direction (pressure-contact direction) of an arrow shown in FIG. 6.

Here, that the cover material is placed around the pressing member 300 means that the cover material is placed around a part of the pressing member 300 including the pressing surface 310 coming into pressure contact with the first bus bar 120.

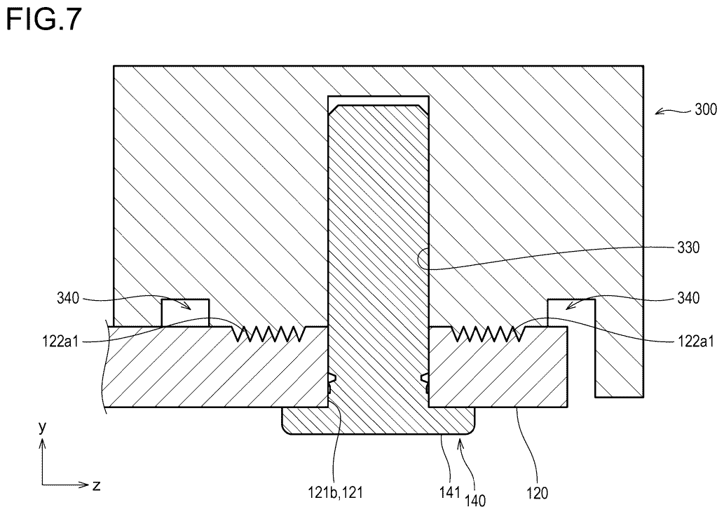

The cover material is a material used to form the cover portion 130 (see FIG. 4). The cover material is a fluid containing a liquid. In FIG. 7, the pressing member 300 comes into pressure contact with the first bus bar 120. In FIG. 7, a gap 340 is formed between the pressing member 300 and the first bus bar 120. In the present embodiment, the cover portion 130 is formed by injection molding. In other words, the cover material is injected into the gap 340 formed between the molding die, which is the pressing member 300, and the first bus bar 120, whereby the cover portion 130 is molded.

Alternatively to the present embodiment in which the injection molding is performed, the cover portion 130 may be formed by immersing a part of the first bus bar 120 and a part of the pressing member 300 in the cover material while allowing the pressing member 300 to come into pressure contact with the first bus bar 120, or the cover portion 130 may be formed by applying the cover material around the pressing member 300.

When the pressing surface 310 comes into pressure contact with the contact portion 122, the unevenness of the pressing surface is transferred to the contact portion 122 to form the unevenness structure 123 (see FIG. 4). As described above, the unevenness 320 is formed on the pressing surface 310. The unevenness 320 corresponds to the shape of the unevenness structure 123.

The protruding height of the convex portion in the unevenness 320 of the pressing surface 310 is preferably greater than the depth of the corresponding concave portion 123a (concave groove 123a) of the unevenness structure 123. The protruding height of the convex portion refers to the dimensions of the convex portion in the protruding direction of the convex portion. The pressing surface 310 having such unevenness 320 with a large protruding height may be pressed against the first bus bar 120 until only a part of the leading end side of each convex portion of the unevenness 320 fits into the first bus bar 120. In other words, the pressing surface 310 may be pressed against the first bus bar 120 to the extent that the concave portion formed between two convex portions in the pressing surface 310 does not completely fit into the first bus bar 120.

Thereby, a part of the first bus bar 120, which is pushed out by coming into pressure contact with the convex portion of the pressing surface 310, can enter the concave portion formed between two convex portions. In this manner, since a space is provided in which the pushed-out part of the first bus bar 120 enters the concave portion, the part prevents from pushing back the pressing member 300, and the unevenness structure 123 is easily formed in the first bus bar 120 or the conductive member. Furthermore, when the part of the first bus bar 120, which is pushed out by the convex portion of the pressing surface 310, relieves into the concave portion, the depth of the formed concave groove 123a becomes larger than the depth to which the convex portion fits into the first bus bar 120. This makes it possible to form the concave groove 123a with a sufficient depth while minimizing the force that presses the pressing member 300.

The unevenness 320 is preferably formed only in a part of the pressing surface 310. Specifically, the pressing surface 310 preferably has a flat surface on which the unevenness 320 is not formed around the unevenness 320 (hereinafter, also referred to as a flat surface). The above-described outer peripheral portion 122b is formed in a flat shape by the flat surface. Convex portions of the unevenness 320 may protrude farther in the protruding direction of the unevenness 320 than the flat surface, or the flat surface may protrude farther in the protruding direction than the convex portions of the unevenness 320.

As described above, the electronic component 100 includes the shaft member 140 that is inserted into the first bus bar 120. In addition, the first bus bar 120 includes the through hole 121 that is open at the contact portion 122 and the rear surface 127 (see FIG. 1A) located on a side opposite in front and back to the contact portion 122. In the present embodiment, the through hole 121 has a shape and dimensions that are small enough that a part of the first bus bar 120 interferes with the shaft member 140 when a shaft portion 142 of the shaft member 140 is inserted. For example, when the through hole 121 has a circular shape in a penetrating direction of the through hole 121 and a transverse section of the shaft portion 142 has a circular shape, a radius of the through hole 121 is smaller than a radius of the transverse section of the shaft portion 142. Thus, the shaft member 140 can be erected in the through hole 121 as will be described below.

The present method may include a step for inserting that is performed before the step for molding. In the step for inserting, the shaft member 140 is inserted into the through hole 121 from the rear surface 127 toward the contact portion 122 (in the y direction) while coming into pressure contact with the peripheral wall surface 121b that defines the through hole 121, and is erected in the through hole 121. That the shaft member 140 is erected in the through hole 121 means that the shaft member 140 is erected so as to intersect with, preferably perpendicular to the contact portion 122. In the present embodiment, the shaft member 140 is inserted into the through hole 121 from the other end opposite to the shaft head portion 141, and is inserted into the through hole 121 upward from below in FIG. 6 until the shaft head portion 141 abuts against the first bus bar 120. When the shaft member 140 is inserted into the through hole 121, the surface region of the contact portion 122 around the through hole 121 may be pressed by a jig (not shown) in a direction opposite to the insertion direction of the shaft member 140. The jig may have a surface for pressing the entire or partial surface region of the contact portion 122, for example. Since the contact portion 122 is pressed by the jig in the direction opposite to the insertion direction of the shaft member 140, the first bus bar 120 can be prevented from being excessively deformed. After the step for inserting, the first bus bar 120 may be a flat plate without being curved, or may have a curved surface that expands in the axial direction of the shaft member 140 as described above.

In the present embodiment, the pressing member 300 includes a relief hole 330 into which the shaft member 140 is housed in the step for molding.

In the above-described step for molding in which the pressing member 300 comes into pressure contact with the first bus bar 120 into which the shaft member 140 is inserted, the shaft member 140 is housed in the relief hole 330 as shown in FIG. 6. The relief hole 330 is a bottomed hole or a through hole provided in the pressing member 300. The relief hole 330 extends in the direction in which the pressing member 300 comes into pressure contact with the first bus bar 120. The shape and dimensions of a transverse section in the extending direction of the relief hole 330 are preferably substantially the same as the shape and dimensions of the transverse section of the shaft portion 142. Thus, the pressing member 300 can come into pressure contact with the first bus bar 120 at a desired position.

Alternatively to the present embodiment, the shape and dimensions of the transverse section in the extending direction of the relief hole 330 may be larger than the shape and dimensions of the transverse section of the shaft portion 142. Thus, a part of the contact portion 122, which is scheduled to form the inner peripheral portion 122c, does not come into pressure contact with the pressing surface 310 of the pressing member 300. Therefore, the inner peripheral portion 122c can protrude farther in the protruding direction of the unevenness structure 123 than the outer peripheral portion 122b in the first bus bar 120 after the step for molding.

The shaft member 140 is inserted before the unevenness structure 123 is formed, and thus the outer surface of the first bus bar 120 is supported with the jig, whereby it is possible to prevent the unevenness structure 123 from being deformed, or prevent the unevenness structure 123 from being crushed and the unevenness region 122a from being made approximately flat.

Note that a series of steps including the step for molding or the step for inserting in the present method may be used as a method for manufacturing the first bus bar 120 instead of the electronic component 100 which is a part of the electronic component.

### (Method for Manufacturing Electric Device)

Hereinafter, a method for the electric device 1 according to the present embodiment (hereinafter, the method for manufacturing the electric device 1 as well as the method for manufacturing the electronic component 100 being sometimes referred to as the present method) will be described. The present method includes a step for joining for joining the first bus bar 120 and the second bus bar 200.

As shown in FIG. 4, in the step for joining, first, the first bus bar 120 and the second bus bar 200 are arranged such that the contact portion 122 faces the facing surface 210 in the second bus bar 200. Here, that the contact portion 122 and the facing surface 210 face each other means that the contact portion 122 and the facing surface 210 have the same direction component as shown in FIG. 4, and preferably the contact portion 122 and the facing surface 210 are approximately parallel to each other.

As shown in FIG. 5A or 5B, in the step for joining, subsequently, the contact portion 122 and the facing surface 210 come into pressure contact with each other, and thus a part of the unevenness structure 123 fits into the second bus bar 200. The contact surface 122 and the facing surface 210 come into pressure contact with each other by stress applied to each other in the direction intersecting (preferably, orthogonal to) the contact surface between the contact surface 122 and the facing surface 210. Hereinafter, such a direction may be referred to as a pressure-contact direction of the contact surface 122 and the facing surface 210, or simply as a pressure-contact direction.

Here, the part of the unevenness structure 123 fitting into the second bus bar 200 is particularly the top portion 123b. The contact portion 122 is pressed against the facing surface 210 with a sufficient force for the top portion 123b to fit into the second bus bar 200. At least the top portion 123b and a part of the concave-groove wall portion 123a2 on the side of the top portion 123b fit into the second bus bar 200. The facing surface 210 is substantially planar before the fit-in, but as the top portion 123b fits into, the unevenness structure 123 is transferred to the facing surface 210, whereby the facing surface 210 becomes a surface having partially unevenness.

The contact portion 122 and the facing surface 210 may come into pressure contact with each other when the shaft head portion 141 biases the first bus bar 120 toward the second bus bar 200. Alternatively, the contact portion 122 and the facing surface 210 may come into pressure contact with each other when the first bus bar 120 and the second bus bar 200 are firmly interposed by a jig (not shown).

As described above, the first bus bar 120 includes the conductor portion 125 and the oxide film 126 that covers the conductor portion 125.

In the present embodiment, the contact portion 122 and the facing surface 210 come into pressure contact with each other in the above-described step for joining, whereby a part of the oxide film 126 coming into pressure contact with the second bus bar 200 is removed, and a part of the conductor portion 125 is exposed to become an exposed portion. The exposed portion and the second bus bar 200 come into contact with each other.

During the process in which the contact portion 122 and the facing surface 210 come into pressure contact with each other and the part of the first bus bar 120 (particularly, the top portion 123b and the part of the concave-groove wall portion 123a2 on the side of the top portion 123b) fits into the second bus bar 200, the first bus bar 120 and the second bus bar 200 rub against each other. Thus, the surface of the oxide film 126 rubbed by the second bus bar 200 in the oxide film 126 covering the outer surface of the first bus bar 120 is partially removed to become thinner, or is completely removed to expose the conductor portion 125. Specifically, in the present embodiment, at least the top portion 123b and the concave-groove wall portion 123a2 come into pressure contact with and rubs against the second bus bar 200. As a result, the oxide film 126 covering the top portion 123b or the concave-groove wall portion 123a2 is removed. More specifically, the oxide film 126 covering the part of the concave-groove wall portion 123a2 on the side of the top portion 123b is removed to expose the inner conductor portion 125, and the surface of the oxide film 126 covering the top portion 123b is partially removed to become thinner.

The reason why the aspect of removing the oxide film 126 at the top portion 123b differs from the aspect of removing the oxide film 126 at the concave-groove wall portion 123a2 is because the aspect of the pressure-contact between the top portion 123b and the facing surface 210 differs from that of the pressure-contact between the concave-groove wall portion 123a2 and the facing surface 210. Specifically, in the present embodiment, the flat top portion 123b is arranged approximately orthogonal to the pressure-contact direction. On the other hand, the concave-groove wall portion 123a2 is arranged parallel to the pressure-contact direction or, preferably, obliquely to the pressure-contact direction. For this reason, the oxide film 126 covering the concave-groove wall portion 123a2 is more likely to be peeled off due to the pressure contact between the first bus bar 120 and the second bus bar 200 than the oxide film 126 covering the top portion 123b. As a result, the oxide film 126 covering the concave-groove wall portion 123a2 is sufficiently removed enough to expose the conductor portion 125, and the oxide film 126 covering the top portion 123b is removed to the extent that the oxide film 126 remains thinly.

The part of the concave-groove wall portion 123a2, from which the oxide film 126 is removed, on the side of the top portion 123b becomes an exposed portion. At the exposed portion of the concave-groove wall portion 123a2, the second bus bar 200 is in direct contact with the conductor portion 125 of the first bus bar 120. At the top portion 123b, the oxide film 126 of the first bus bar 120 is in contact with the second bus bar 200.

In the present embodiment, the oxide film 126 covering the top portion 123b remains thinly, but alternatively to the present embodiment, the oxide film 126 covering the top portion 123b may be completely removed to expose the top portion 123b. In this case, the conductor portion 125 and the second bus bar 200 are in direct contact with each other in at least a part of the top portion 123b that is exposed after the oxide film 126 is removed.

Furthermore, the outer peripheral portion 122b may be or may not be in contact with the facing surface 210 of the second bus bar 200. When the outer peripheral portion 122b is in contact with the facing surface 210 of the second bus bar 200, the surface of the oxide film 126 covering a part of the outer peripheral portion 122b facing and being in contact with the second bus bar 200 may be removed to become thin. Alternatively, the oxide film 126 covering the part of the outer peripheral portion 122b may be removed enough to expose the conductor portion 125.

Alternatively to the present embodiment, even when the second bus bar 200 is pressure-contacted, the oxide film 126 may remain over the entire region of the unevenness structure 123 without being completely removed. Specifically, the oxide film 126, of which the surface is thinned by being partially peeled off due to rubbing, may remain over the entire region of the unevenness structure 123. In this case, the electrical connection between the second bus bar 200 and the first bus bar 120 is improved by the oxide film 126 that becomes thin. In addition, since the whole of the unevenness structure 123 including the concave-groove wall portion 123a2 and the like is the covering portion, the conductor portion 125 can be protected over approximately the entire region of the unevenness structure 123.

As described above, the second bus bar 200 also includes the second conductor portion 220 and the second oxide film 230 covering the second conductor portion 220. Since the top portion 123b and the concave-groove wall portion 123a2 rub against the second bus bar 200, the second oxide film 230 covering the second bus bar 200 is also removed to become thin, or is removed and peeled off enough to expose the conductor portion 125. Specifically, in the present embodiment, after the step for joining, a part of the outer surface of the second bus bar 200 facing the concave-groove wall portion 123a2 is a second exposed portion that is not covered with the second oxide film 230. In addition, after the step for joining, a part of the outer surface of the second bus bar 200 facing the top portion 123b has the second oxide film 230 that is worn away and becomes thin. The thickness of the second oxide film 230 covering the part of the outer surface of the second bus bar 200 facing the top portion 123b is smaller than the thickness of the second oxide film 230 covering the part of the outer surface of the second bus bar 200 facing the concave-groove bottom portion 123a1.

The present invention is not limited to the above-described embodiments, and includes various modifications, improvements, and other aspects as long as the object of the present invention is achieved.

The following modifications can be combined as appropriate.

In the present embodiment, the electronic component 100 may not include the shaft member 140 and the through hole 121. In this case, the first bus bar 120 and the bus bar 200 are interposed between other members, and thus the first bus bar 120 and the second bus bar 200 may be joined.

The methods for manufacturing the electronic component 100, the electric device 1, and the first bus bar 120 in the present embodiment are not limited to the above-described methods.

For example, the step for inserting may be performed after the step for molding. In this case, the concave groove 123a may be formed to be sufficiently deep. Thus, the concave groove 123a can have a sufficient depth dimension even when the contact portion 122 of the first bus bar 120 is pressed and supported by a jig during the insertion of the shaft member 140 into the through hole 121.

In addition, the step for embossing the unevenness of forming the unevenness structure 123 may be performed separately from the step for molding. For example, the step for molding may be performed after the step for embossing the unevenness. In this case, the molding die used in the step for molding such that the cover material is not placed on the contact portion 122 may have a configuration in which a surface of the molding die presses the peripheral edge (for example, the outer peripheral portion 122b) of the contact portion 122 and is separated from the center side (the scheduled unevenness region forming portion 122a1) of the contact portion 122.

In the step for inserting, the shaft member 140 may be inserted from the contact portion 122 toward the rear surface 127. In this case, it is preferable that the shaft member 140 does not include the shaft head portion 141.

The above embodiments involves the following technical ideas.

(1) A method for manufacturing an electronic component including a main body that includes an electronic element, a bus bar that is electrically connected to the electronic element, and a cover portion that covers a part of an outer surface of the bus bar, the method comprising
molding the cover portion by placing a cover material on the part, and
in molding the cover portion,
a pressing member including a pressing surface with unevenness is used,
the pressing member covers another part of the outer surface such that the pressing surface comes into pressure contact with the another part, the cover material is placed around the pressing member to mold the cover portion, and
the unevenness is transferred to the another part when the pressing surface comes into pressure contact with the another part, thereby forming an unevenness structure.

(2) In the method for manufacturing an electronic component according to (1), the electronic component includes a shaft member that is inserted into the bus bar,
the bus bar includes a through hole that opens at the another part and at a rear surface located on a side opposite in front and back to the another part,
the method includes, prior to molding the cover portion, inserting the shaft member into the through hole from the rear surface toward the another part while the shaft member comes into pressure contact with a peripheral wall surface, which defines the through hole, so that the shaft member is erected in the through hole and
the pressing member includes a relief hole in which the shaft member is housed in molding the cover portion.

(3) An electronic component including: a main body that includes an electronic element; a bus bar that is electrically connected to the electronic element; and a cover portion that covers a part of an outer surface of the bus bar, in which,
an unevenness region having an unevenness structure is formed on a contact portion, which is exposed from the cover portion, on the outer surface.

(4) In the electronic component according to (3), the bus bar includes a through hole that opens at the contact portion,
the electronic component includes a shaft member that is inserted into the through hole, and
the unevenness region is arranged around the shaft member as viewed in an axial direction of the shaft member.

(5) In the electronic component according to (4), the contact portion includes an inner peripheral portion that is located closer to the shaft member than the unevenness region, and
the inner peripheral portion is flat.

(6) In the electronic component according to (5), the contact portion includes an outer peripheral portion that is arranged around the unevenness region, and
the inner peripheral portion protrudes farther in a protruding direction of the unevenness structure than the outer peripheral portion.

(7) In the electronic component according to (5) or (6), the unevenness structure includes a plurality of protrusion portions, and
a protrusion end of each of the protrusion portions protrudes farther in a protruding direction of the unevenness structure than the inner peripheral portion.

(8) In the electronic component according to any one of (4) to (7), the unevenness structure has a concave portion that has a bottom, and
a part of the concave portion has a larger depth dimension than another part of the concave portion arranged on a side closer to a peripheral edge of the unevenness region.

(9) In the electronic component according to any one of (4) to (8), the contact portion includes an outer peripheral portion that is arranged around the unevenness region,
the outer surface of the bus bar includes an adjacent portion that is adjacent to the outer peripheral portion as viewed in an axial direction of the shaft member and is covered by the cover portion,
a step is formed between the outer peripheral portion and the adjacent portion to rise from the outer peripheral portion toward the adjacent portion, and
a step surface of the step is continuous with a side end surface of the cover portion.

(10) A bus bar in which a part of an outer surface is covered by a cover portion, and another part of the outer surface is formed with an unevenness structure.

### REFERENCE SIGNS LIST

1 electric device
100 electronic component
110 main body
111 electronic element
120 first bus bar
121 through hole
121b peripheral wall surface
122 contact portion
122a unevenness region
122a1 scheduled unevenness region forming portion
122b outer peripheral portion
122c inner peripheral portion
123 unevenness structure
123a concave groove, concave portion
123a1 concave-groove bottom portion
123a2 concave-groove wall portion
123b top portion, protrusion end
123e protrusion portion
124 adjacent portion
124a step surface
125 conductor portion
126 oxide film
127 rear surface
130 cover portion
131 inward end surface
140 shaft member
141 shaft head portion
142 shaft portion
143 nut
200 second bus bar
210 facing surface
220 second conductor portion
230 second oxide film
300 pressing member
310 pressing surface
320 unevenness
330 relief hole
340 gap

1. A method for manufacturing an electronic component including a main body that includes an electronic element, a bus bar that is electrically connected to the electronic element, and a cover portion that covers a part of an outer surface of the bus bar, the method comprising
molding the cover portion by placing a cover material on the part, and
in molding the cover portion,
a pressing member including a pressing surface with unevenness is used,
the pressing member covers another part of the outer surface such that the pressing surface comes into pressure contact with the another part, the cover material is placed around the pressing member to mold the cover portion, and
the unevenness is transferred to the another part when the pressing surface comes into pressure contact with the another part, thereby forming an unevenness structure.

2. The method for manufacturing an electronic component according to claim 1, wherein the electronic component includes a shaft member that is inserted into the bus bar,
the bus bar includes a through hole that opens at the another part and at a rear surface located on a side opposite in front and back to the another part,
the method includes, prior to molding the cover portion, inserting the shaft member into the through hole from the rear surface toward the another part while the shaft member comes into pressure contact with a peripheral wall surface, which defines the through hole, so that the shaft member is erected in the through hole and
the pressing member includes a relief hole in which the shaft member is housed in molding the cover portion.

3. An electronic component comprising:
a main body that includes an electronic element;
a bus bar that is electrically connected to the electronic element; and
a cover portion that covers a part of an outer surface of the bus bar, wherein
an unevenness region having an unevenness structure is formed on a contact portion, which is exposed from the cover portion, on the outer surface.

4. The electronic component according to claim 3, wherein the bus bar includes a through hole that opens at the contact portion,
the electronic component includes a shaft member that is inserted into the through hole, and
the unevenness region is arranged around the shaft member as viewed in an axial direction of the shaft member.

5. The electronic component according to claim 4, wherein the contact portion includes an inner peripheral portion that is located closer to the shaft member than the unevenness region, and
the inner peripheral portion is flat.

6. The electronic component according to claim 5, wherein the contact portion includes an outer peripheral portion that is arranged around the unevenness region, and
the inner peripheral portion protrudes farther in a protruding direction of the unevenness structure than the outer peripheral portion.

7. The electronic component according to of claim 5, wherein the unevenness structure includes a plurality of protrusion portions, and
a protrusion end of the protrusion portion protrudes farther in a protruding direction of the unevenness structure than the inner peripheral portion.

8. The electronic component according to claim 4, wherein the unevenness structure has a concave portion that has a bottom, and
a part of the concave portion has a larger depth dimension than another part of the concave portion arranged on a side closer to a peripheral edge of the unevenness region.

9. The electronic component according to claim 4, wherein the contact portion includes an outer peripheral portion that is arranged around the unevenness region,
the outer surface of the bus bar includes an adjacent portion that is adjacent to the outer peripheral portion as viewed in an axial direction of the shaft member and is covered by the cover portion,
a step is formed between the outer peripheral portion and the adjacent portion to rise from the outer peripheral portion toward the adjacent portion, and
a step surface of the step is continuous with a side end surface of the cover portion.

10. A bus bar in which a part of an outer surface is covered by a cover portion, and another part of the outer surface is formed with an unevenness structure.
